(19) United States
(12) Patent Application Publication
(10) Pub. No.: US 2025/0141543 A1
(43) Pub. Date: May 1, 2025

(54) OPTICAL TRANSMISSION LINE MONITORING DEVICE AND OPTICAL TRANSMISSION LINE MONITORING METHOD

(71) Applicant: Fujitsu Limited, Kawasaki (JP)

(72) Inventors: Junichi SUGIYAMA, Kawasaki (JP); Atsushi KANAI, Kawasaki (JP)

(73) Assignee: Fujitsu Limited, Kawasaki (JP)

(21) Appl. No.: 18/889,447

(22) Filed: Sep. 19, 2024

(30) Foreign Application Priority Data
Oct. 30, 2023 (JP) 2023-185153

(51) Int. Cl. H04B 10/077; H04B 10/079

(52) U.S. Cl. CPC H04B 10/0779; H04B 10/0791

(57) ABSTRACT

Polarization fluctuation occurs in optical transmission line between first terminal node and second terminal node is monitored. Delay measurement for each of a plurality of spans constituting the optical transmission line is performed. Processor in optical transmission line monitoring device calculates, for each of the plurality of spans, refractive index of optical fiber laid in the span based on span length and the delay measurement value. The processor calculates propagation time of light between the first terminal node and a polarization fluctuation position based on timing information indicating timing at which polarization fluctuation generated on the optical transmission line is detected in each of the first and second terminal nodes. The processor calculates a distance between the first terminal node and the polarization fluctuation position based on the propagation time and the refractive index calculated for each of the plurality of spans.

### CROSS-REFERENCE TO RELATED APPLICATION

This application is based upon and claims the benefit of priority of the prior Japanese Patent Application No. 2023-185153, filed on Oct. 30, 2023, the entire contents of which are incorporated herein by reference.

### FIELD

The embodiments discussed herein are related to a device and a method of monitoring an optical transmission line.

### BACKGROUND

In an optical communication system, coherent transmission has become mainstream due to an increase in transmission speed. In coherent transmission, a signal is transmitted using a phase and a polarization of light. For this reason, when the polarization rapidly fluctuates on the optical transmission line, a burst error may occur in the reception node.

In addition, as the transmission capacity of the network increases, a modulation scheme in which the number of bits that can be transmitted by each symbol is large is adopted. However, in optical communication using such a modulation scheme, polarization fluctuation caused by shaking of an optical fiber, lightning strike, or the like may greatly affect communication quality. For this reason, a technique for specifying a position where polarization fluctuation occurs on an optical transmission line has attracted attention (for example, Japanese Laid-open Patent Publication No. 2023-043154).

The position where the polarization fluctuation occurs (polarization fluctuation position) may be specified based on, for example, the timing at which the polarization fluctuation is detected in one set of terminal nodes connected to both ends of the optical transmission line. In this case, the propagation time of light between the terminal node and the polarization fluctuation position is calculated, and the polarization fluctuation position is specified from the propagation time. Here, the speed of light propagating through the optical transmission line depends on the refractive index of the optical fiber. That is, the refractive index of the optical fiber is used in the calculation for specifying the polarization fluctuation position.

However, the refractive index varies for each optical fiber. For example, the refractive index of a general optical fiber is 1.468, but the refractive index of optical fibers commercially available from some vendors varies by about ±1.5% (1.45 to 1.49). For this reason, when the polarization fluctuation position is specified by the related art, an error may increase.

### SUMMARY

According to an aspect of the embodiments, an optical transmission line monitoring device includes a processor to specify a polarization fluctuation position representing a position where polarization fluctuation occurs in an optical transmission line between a first terminal node and a second terminal node. The processor acquires a delay measurement value representing a result of delay measurement between nodes for each of a plurality of transmission line. The spans constituting the optical processor calculates, for each of the plurality of spans, a refractive index of an optical fiber laid in the span based on a span length representing the length of the span and the delay measurement value. The processor calculates a propagation time of light between the first terminal node and the polarization fluctuation position based on timing information indicating timing at which polarization fluctuation generated on the optical transmission line is detected in each of the first terminal node and the second terminal node. The processor calculates a distance between the first terminal node and the polarization fluctuation position based on the propagation time and the refractive index calculated for each of the plurality of spans.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A to 1D illustrate an example of a method of specifying an occurrence position of polarization fluctuation;

FIG. 2 illustrates an example of an optical transmission system in which an optical transmission line is configured of a plurality of spans;

FIG. 3 is a diagram illustrating an outline of a method for obtaining a refractive index of an optical fiber for each span;

FIG. 4 illustrates an example of an allocation of OSC;

FIG. 5 illustrates an example of a function of detecting polarization fluctuation;

FIG. 6 illustrates an example of span delay measurement using OSC;

FIG. 7 is a diagram illustrating points at which a delay may occur;

FIG. 8 illustrates an example of a functional configuration of an optical transmission line monitoring device according to an embodiment of the present disclosure;

FIG. 9 is a flowchart illustrating an example of a method of calculating a refractive index of an optical fiber laid in each span of an optical transmission line;

FIG. 10 is a flowchart illustrating an example of a process of specifying a polarization fluctuation position;

FIG. 11 is a flowchart illustrating an example of a process of calculating a distance from a terminal node to a polarization fluctuation position;

FIG. 12 illustrates an example of a method of calculating a distance from a terminal node to a polarization fluctuation position; and

FIGS. 13A to 13C are diagrams illustrating effects according to the embodiment of the present disclosure.

### DESCRIPTION OF EMBODIMENTS

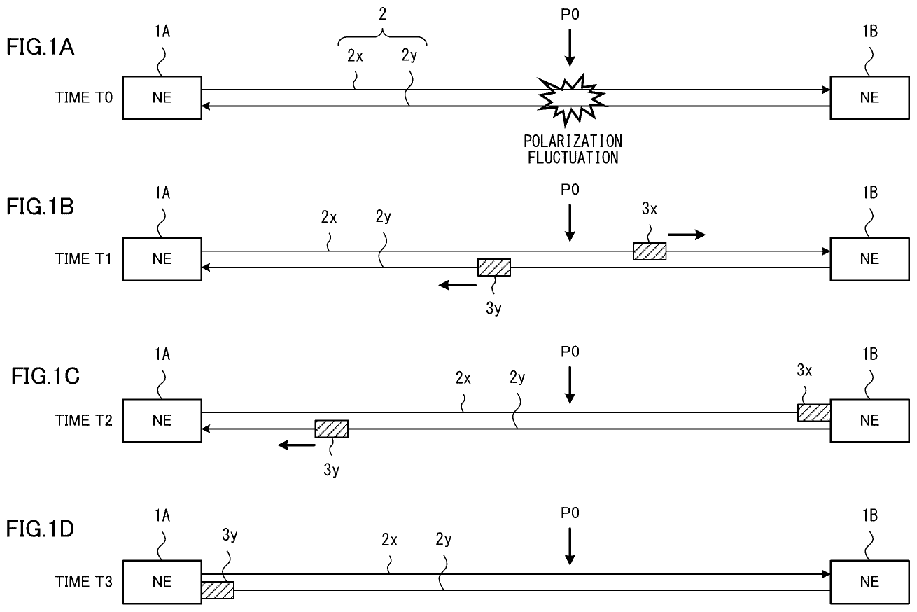

FIGS. 1A to 1D illustrate an example of a method of specifying an occurrence position of polarization fluctuation. In this example, an optical transmission system includes an optical transmission device (NE: Network Element) 1A and an optical transmission device (NE) 1B. The optical transmission device 1A and the optical transmission device 1B are connected to each other by an optical transmission line 2. That is, the optical transmission device 1A and the optical transmission device 1B are provided at both ends of the optical transmission line 2. Each of the optical transmission devices 1A and 1B includes a transponder. The transponder includes a processor such as an optical transmitter, an optical receiver, and a digital signal processor (DSP).

The optical transmission line 2 includes one set of an optical fiber 2x and an optical fiber 2y. The optical fiber 2x propagates an optical signal from the optical transmission device 1A to the optical transmission device 1B, and the optical fiber 2y propagates an optical signal from the optical transmission device 1B to the optical transmission device 1A. The optical fiber 2x and the optical fiber 2y are laid adjacent to each other. Although not particularly limited, the optical fiber 2x and the optical fiber 2y are accommodated in the same cable.

Here, as illustrated in FIG. 1A, it is assumed that the state of polarization (SOP) of the optical transmission line 2 rapidly fluctuates at time TO. In FIGS. 1A to 1D, P0 represents a position where polarization fluctuation occurs. In the following description, the position where the polarization fluctuation occurs may be referred to as a “polarization fluctuation position”.

When the polarization of the optical transmission line 2 fluctuates, the polarization state of light propagating through the optical fibers 2x and 2y is affected. In the following description, an optical component whose polarization state is affected in the optical fiber 2x may be referred to as a polarization fluctuation component 3x, and an optical component whose polarization state is affected in the optical fiber 2y may be referred to as a polarization fluctuation component 3y.

The polarization fluctuation component 3x propagates from the position P0 toward the optical transmission device 1B via the optical fiber 2x. The polarization fluctuation component 3y propagates from the position P0 toward the optical transmission device 1A via the optical fiber 2y. Therefore, as illustrated in FIG. 1B, the polarization fluctuation components 3x and 3y reach positions separated from the position P0 by a specified distance at time T1.

Thereafter, the polarization fluctuation component 3x arrives at the optical transmission device 1B at time T2 as illustrated in FIG. 1C. Further, the polarization fluctuation component 3y arrives at the optical transmission device 1A at time T3 as illustrated in FIG. 1D. Then, the position P0 can be calculated based on the difference AT between the time T2 and the time T3. Here, it is assumed that a propagation time TL of light between the optical transmission devices 1A and 1B is obtained by measurement or calculation. In this case, a propagation time “T (A-P0)” between the optical transmission device 1A and the position P0 is expressed by Formula (1).

$$T ( A - P 0 ) = \frac{TL + Δ T}{2} \qquad ( 1 )$$

Furthermore, a distance “D (A-P0)” between the optical transmission device 1A and the position P0 is expressed by Formula (2). n represents the refractive index of the optical fiber, and c represents the speed of light in vacuum.

$$D ( A - P 0 ) = \frac{c}{n} \times T ( A - P 0 ) \qquad ( 2 )$$

In this manner, the polarization fluctuation position P0 can be specified by measuring the time when the polarization fluctuation is detected at the nodes at both ends of the optical transmission line 2. At this time, the refractive index n of the optical fiber is used.

Note that, in the cases illustrated in FIGS. 1A to 1D, time synchronization is established between the optical transmission device 1A and the optical transmission device 1B. However, even if the time (alternatively, the counter) between the optical transmission device 1A and the optical transmission device 1B is not synchronized with each other, the polarization fluctuation position P0 can be specified by detecting the polarization fluctuation at the nodes at both ends of the optical transmission line 2. For example,

Japanese Laid-open Patent Publication No. 2023-043154 discloses a method for specifying a polarization fluctuation position by detecting polarization fluctuation in each node in a configuration in which time (alternatively, the counter) is not the same at the nodes at both ends of an optical transmission line.

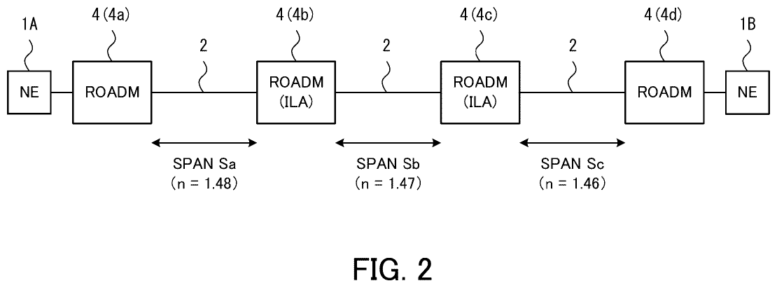

FIG. 2 illustrates an example of an optical transmission system in which an optical transmission line is configured of a plurality of spans. In this example, a wavelength division multiplexed (WDM) signal is transmitted via the optical transmission line 2. The WDM signal transmits a plurality of optical signals by using a plurality of wavelength channels. Therefore, a reconfigurable optical add drop multiplexer (ROADM) 4 is provided in each node. The ROADM 4 can branch an optical signal of a desired wavelength from the WDM signal. In addition, the ROADM 4 can insert an optical signal into an empty channel of the WDM signal.

An optical transmission device (NE) 1A and a ROADM 4a may be provided in one terminal node of the optical transmission line 2, and an optical transmission device (NE) 1B and a ROADM 4d may be provided in the other terminal node. Note that, in this embodiment, the optical transmission device 1A is connected to the ROADM 4a with a short optical fiber, and the optical transmission device 1B is connected to the ROADM 4d with a short optical fiber. A ROADM 4 (4b and 4c) is provided in each node between the ROADM 4a and the ROADM 4d. Instead of the ROADMs 4b and 4c, in-line amplifiers (ILA) may be provided, respectively. The in-line amplifier collectively amplifies the WDM signal with a specified gain.

In the optical transmission system having the above configuration, an optical signal transmitted between the optical transmission device 1A and the optical transmission device 1B propagates through the optical transmission line 2 without being converted into an electrical signal in each of the ROADMs (4a to 4d). Therefore, when polarization fluctuation occurs on the optical transmission line 2, each of the optical transmission device 1A and the optical transmission device 1B can detect the polarization fluctuation. Therefore, the polarization fluctuation position can be specified by the method described with reference to FIGS. 1A to 1D.

In the method described with reference to FIGS. 1A to 1D, the refractive index of the optical fiber is used when specifying the polarization fluctuation position. However, the refractive index of the optical fiber varies. Therefore, when a general refractive index value (for example, is used, the calculated polarization fluctuation 1.468) position includes an error. Specifically, assuming that the refractive index of a commercially available optical fiber has a variation of about ±1.5% (1.45 to 1.49), the calculated polarization fluctuation position also includes an error of ±1.5% at the maximum. In this case, for example, when the distance from a terminal node to the polarization fluctuation position obtained by calculation is 100 km, an error of #1.5 km is included.

Therefore, in order to accurately specify the polarization fluctuation position, the optical transmission line monitoring device according to the embodiment of the present disclosure has a function of obtaining the refractive index of the optical fiber laid in each span constituting the optical transmission line. By using this function, in this embodiment, 1.48, 1.47, and 1.46 are obtained as the refractive indexes of the optical fibers laid in the spans Sa, Sb, and Sc, respectively. Then, the optical transmission line monitoring device calculates the polarization fluctuation position using these refractive index values. As a result, the polarization fluctuation position is accurately specified.

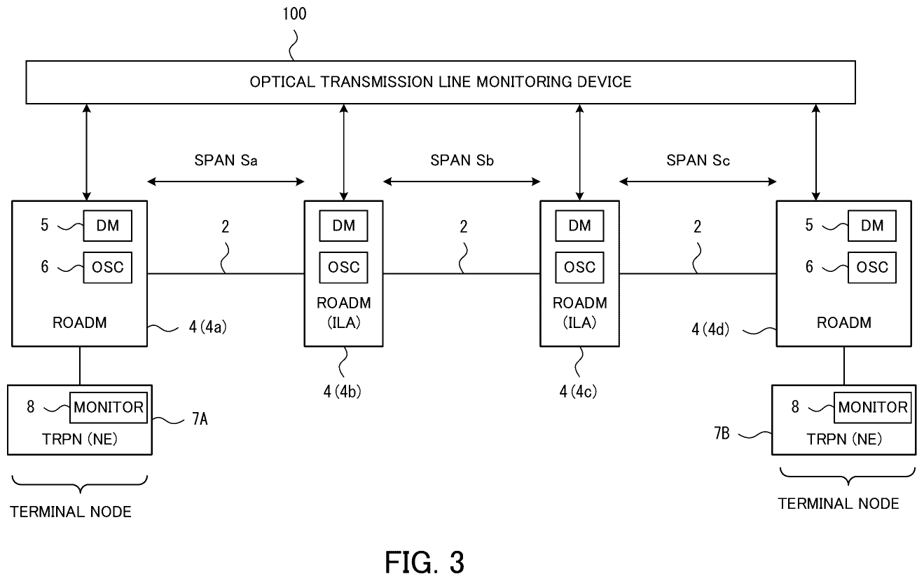

FIG. 3 is a diagram illustrating an outline of a method for obtaining a refractive index of an optical fiber for each span. In this example, the ROADM (or ILA) 4 is provided in each node of the optical transmission system. Each ROADM 4 includes a delay measurement (DM) frame processing unit 5 and an optical supervisory channel (OSC) circuit 6. In addition, a transponder (TRPN) 7A is connected to the ROADM provided at one terminal node, and a transponder (TRPN) 7B is connected to the ROADM provided at the other terminal node. The transponders 7A and 7B correspond to the optical transmission devices 1A and 1B in the examples illustrated in FIGS. 1A to 1D.

The DM frame processing unit 5 generates a DM frame and transmits the DM frame to the adjacent node. The DM frame has a specified format and is used to measure a delay time of a span between adjacent nodes. In addition, at the time of transmitting the DM frame, the DM frame processing unit 5 adds a time stamp indicating a transmitting time to the DM frame. Further, when receiving the DM frame from the adjacent node, the DM frame processing unit 5 returns the DM frame to the transmission source. Therefore, the DM frame processing unit 5 can measure the delay time (in this embodiment, a round-trip time (RTT)) with the adjacent node by receiving the DM frame transmitted by itself. Note that the DM frame processing unit 5 is not particularly limited, but is preferably implemented by, for example, a hardware circuit such as a field programmable gate array (FPGA). In this case, since the processing time by the DM frame processing unit 5 is sufficiently short, the delay time can be accurately measured. Note that the DM frame processing unit 5 is an example of a delay measurement unit that measures a delay time of a span with an adjacent node.

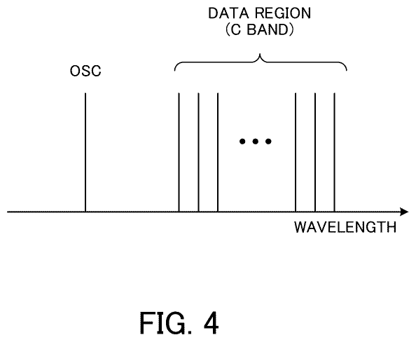

The OSC circuit 6 uses OSC to transmit a control signal between nodes. The DM frame described above is transmitted to the adjacent node via OSC by the OSC circuit 6. Here, as illustrated in FIG. 4, the OSC is configured using a wavelength different from a wavelength region (for example, C band) for transmitting a data signal. As an example, the wavelength of the OSC is 1511 nm (or 198.4 THz).

For example, the DM frame processing unit 5 of the ROADM 4a transmits a DM frame to the ROADM 4b. A time stamp indicating a transmitting time is added to the DM frame. Then, the DM frame is transmitted to the ROADM 4b via the OSC. The DM frame processing unit 5 of the ROADM 4b returns the received DM frame to the ROADM 4a. The DM frame is transmitted to the ROADM 4a via the OSC. Then, the DM frame processing unit 5 of the ROADM 4a can measure the delay time between the ROADM 4a and the ROADM 4b by referring to the time stamp attached to the DM frame received from the ROADM 4b.

Similarly, the delay time is measured for other spans. Then, the delay time for each span is notified to the optical transmission line monitoring device 100.

The transponders (7A and 7B) provided in the nodes at both ends of the optical transmission line 2 include polarization fluctuation monitors 8. The polarization fluctuation monitor 8 monitors the state of polarization (SOP) of the received optical signal. When detecting the polarization fluctuation larger than a specified threshold level, the polarization fluctuation monitor 8 notifies the optical transmission line monitoring device 100 that the polarization fluctuation has occurred. For example, in the cases illustrated in FIGS. 1A to 1D, the polarization fluctuation monitor 8 provided in the NE 1B notifies the optical transmission line monitoring device 100 that the polarization fluctuation is detected at time T2. In addition, the polarization fluctuation monitor 8 provided in the NE 1A notifies the optical transmission line monitoring device 100 that the polarization fluctuation is detected at time T3.

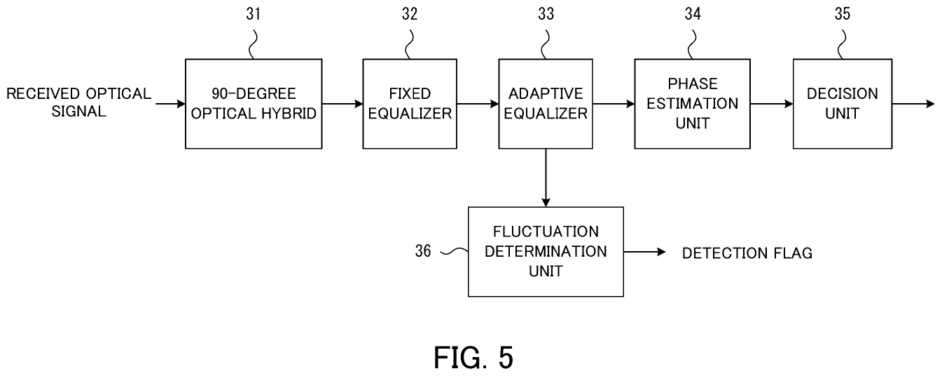

FIG. 5 illustrates an example of a function of detecting polarization fluctuation. The function of detecting polarization fluctuation is achieved by using a receiver that reproduces a symbol from a received optical signal. In this example, the receiver includes a 90-degree optical hybrid circuit 31, a fixed equalizer 32, an adaptive equalizer 33, a phase estimation unit 34, a decision unit 35, and a fluctuation determination unit 36.

The 90-degree optical hybrid circuit 31 generates an electric signal representing the electric field of the received optical signal using a local light source (not illustrated). The fixed equalizer 32 equalizes the output signal of the 90-degree optical hybrid circuit 31. For example, wavelength dispersion and the like are compensated for by the fixed equalizer 32. The adaptive equalizer 33 includes a digital filter such as an FIR filter, and adaptively equalizes the output signal of the fixed equalizer 32. Furthermore, the adaptive equalizer 33 performs polarization separation. At this time, the coefficient of each tap of the digital filter may be updated based on the input signal and the output signal of the adaptive equalizer 33.

The phase estimation unit 34 compensates for the phase offset of the output signal of the adaptive equalizer 33. As a result, the phase of each symbol is reproduced. The decision unit 35 reproduces the data assigned to each symbol in the transmission node based on the output signal of the phase estimation unit 34.

The fluctuation determination unit 36 monitors the polarization fluctuation generated in the optical transmission line 2 between the ROADM 4a and the ROADM 4d based on the output signal of the adaptive equalizer 33 or the tap coefficients of the digital filter included in the adaptive equalizer 33. When the polarization fluctuation is larger than a specified threshold level, the fluctuation determination unit 36 outputs the polarization fluctuation detection flag. That is, the polarization fluctuation detection flag indicates that polarization fluctuation larger than a specified threshold level has occurred in the optical transmission line 2.

Note that the fluctuation determination unit 36 is implemented by, for example, a digital signal processing circuit that is a hardware circuit. Alternatively, the fluctuation determination unit 36 may be implemented by a processor system including a processor and a memory. In this case, the processor provides the function of the fluctuation determination unit 36 by executing a program that outputs a detection flag when detecting the polarization fluctuation.

The polarization fluctuation monitor 8 illustrated in FIG. 3 corresponds to the fluctuation determination unit 36 illustrated in FIG. 5. Alternatively, the polarization fluctuation monitor 8 corresponds to the 90-degree optical hybrid 31, the fixed equalizer 32, the adaptive equalizer 33, and the fluctuation determination unit 36. Then, the polarization fluctuation monitor 8 outputs the polarization fluctuation detection flag when polarization fluctuation larger than a specified threshold level occurs in the optical transmission line 2. As a result, the optical transmission line monitoring device 100 is notified of the time when the polarization fluctuation is detected.

The optical transmission line monitoring device 100 calculates the refractive index of the optical fiber laid in each span based on the delay time measured for each span. At this time, it is preferable to calculate the refractive index based on the minimum value of the delay times measured a plurality of times for each span. In addition, the optical transmission line monitoring device 100 calculates a propagation time of light between the terminal node of the optical transmission line 2 and the polarization fluctuation position. This propagation time is not particularly limited, but is calculated, for example, by the method described with reference to FIGS. 1A to 1D. Further, the optical transmission line monitoring device 100 specifies the distance between the terminal node of the optical transmission line 2 and the polarization fluctuation position (that is, the polarization fluctuation position is determined) based on the refractive index of each span and the propagation time of light between the terminal node of the optical transmission line 2 and the polarization fluctuation position.

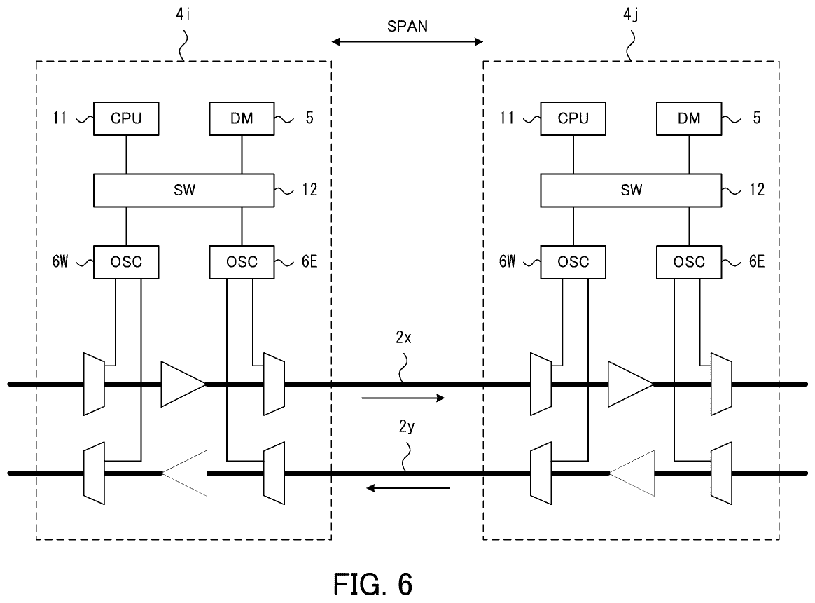

FIG. 6 illustrates an example of span delay measurement using OSC. In this example, the propagation delay between ROADM 4i and ROADM 4j is measured. ROADMs 41 and 4j each represent a ROADM 4 (or ILA) provided at any node of the optical transmission line 2. However, the ROADMs 41 and 4j are provided in nodes adjacent to each other. One set of optical fibers is laid in the span between the ROADMs 4i and 4j. The optical fiber 2x propagates an optical signal from the ROADM 4i to the ROADM 4j, and the optical fiber 2y propagates an optical signal from the ROADM 4j to the ROADM 4i.

Each of the ROADMs 4i and 4j includes an optical amplifier that amplifies the received WDM signal. An optical device that extracts an OSC signal from a received optical signal is provided on an input side of the optical amplifier. An optical device that multiplexes the WDM signal and the OSC signal is provided on the output side of the optical amplifier. Note that the ROADM further includes a wavelength selection switch (WSS), which is not illustrated for ease of viewing the drawing. The WSS can process optical signals for each wavelength channel.

The CPU 11 controls operation of the ROADM. In addition, the CPU 11 generates a control signal for controlling the optical transmission system. This control signal is transmitted to a ROADM provided in another node by the OSC circuits 6W and 6E. As described above, the DM frame processing unit 5 processes the DM frame used for delay measurement. Then, the DM frame processing unit 5 obtains a propagation delay with the adjacent node by performing delay measurement using the DM frame.

The switch 12 controls connection between the CPU 11 and the OSC circuits 6W and 6E, and also controls connection between the DM frame processing unit 5 and the OSC circuits 6W and 6E. Note that the switch 12 is, for example, an L2 switch that processes a layer 2 frame.

When the propagation delay between the ROADMs 4i and 4j is measured, for example, the DM frame processing unit 5 of the ROADM 4i generates a DM frame. A time stamp indicating a transmitting time is added to the DM frame. The DM frame is guided to the OSC circuit 6E by the switch 12. Then, the OSC circuit 6E transmits the DM frame to the ROADM 4j using the OSC. Then, the DM frame is propagated through the optical fiber 2x and arrives at the ROADM 4j.

In the ROADM 4j, the OSC circuit 6W extracts the DM frame from the OSC. The DM frame is guided to the DM frame processing unit 5 by the switch 12. The DM frame processing unit 5 returns the DM frame to the ROADM 41. At this time, the DM frame is guided to the OSC circuit 6W by the switch 12. The OSC circuit 6W transmits the DM frame to the ROADM 4i using the OSC. Then, the DM frame is propagated through the optical fiber 2y and arrives at the ROADM 41.

In the ROADM 4i, the OSC circuit 6E extracts the DM frame from the OSC. The DM frame is guided to the DM frame processing unit 5 by the switch 12. Then, the DM frame processing unit 5 calculates a difference between the time stamp attached to the DM frame and the current time. As a result, a propagation delay value between the ROADMs 4i and 4j is obtained.

In the embodiment illustrated in FIG. 6, the optical fiber that transmits the DM frame from the ROADM 4j to the ROADM 4i may be the same as the optical fiber that transmits the DM frame from the ROADM 4i to the ROADM 4j. However, in this case, since OSC signals having the same wavelength are mixed in one optical fiber, the quality of the signal is deteriorated. Therefore, in order to avoid this problem, OSC signals of different wavelengths may be used. In the embodiment illustrated in FIG. 6, the RTT of the span is measured. However, when the time of each node is synchronized, the transmission delay may be measured in the ROADM 4j by transmitting a DM frame from the ROADM 4i to the ROADM 4j.

As described above, a propagation delay between nodes is measured by using the DM frame. However, in the configuration illustrated in FIG. 6, in each ROADM, the DM frame is processed by the switch 12. Here, the switch 12 processes not only the DM frame but also the control frame generated by the CPU 11. Therefore, when the amount of control frames generated by the CPU 11 is large, the switch 12 may be congested. Then, when the switch 12 is congested, the propagation time of the DM frame may not be accurately measured.

Therefore, in the optical transmission line monitoring method according to the embodiment, the delay measurement is performed a plurality of times for each span. Then, the optical transmission line monitoring device 100 adopts the smallest value among the plurality of measured values as the propagation delay value for each span.

Here, the switch 12 is not always congested and is congested when it competes with other frames (for example, a control frame generated by the CPU 11). For example, it is assumed that the processing capability of the switch 12 is 1 Gbps and the average rate of signals passing through the switch 12 is 800 Mbps. In this case, in a case in which the usage rate of the switch 12 is 80% and the DM frame arrives in the remaining 20% period, the DM frame is not delayed in the switch 12.

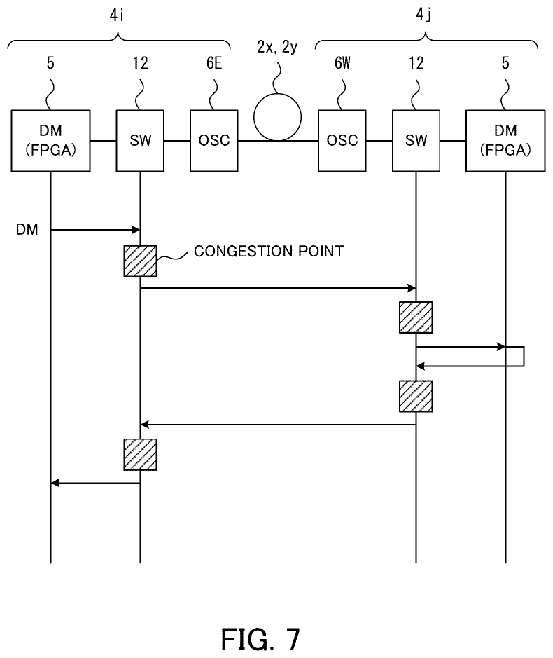

On the other hand, in this embodiment, the DM frame is processed by the switch 12 four times in one delay measurement, as illustrated in FIG. 7. That is, the DM frame passes through four congestion points in one delay measurement. Note that a method of specifying a propagation delay by reciprocating a DM frame between one set of nodes is supported in, for example, Ethernet (registered trademark).

In this case, a probability that the DM frame is not affected by congestion is 0.2 to the power of 4, which is 0.16 percent. That is, a probability that a DM frame is affected by congestion is 99.84 percent. Therefore, for example, if 10,000 delay measurements are performed, the probability that all delay measurements are affected by congestion is 0.9984 to the power of 10,000, which is about 0.0001 percent. In other words, when performing 10, 000 times of delay measurement, a probability of obtaining one or more propagation delay values not affected by congestion is 99.9999 percent. Therefore, if a minimum value is detected from the 10,000 measured values, a delay measurement value that is not affected by congestion can be obtained with a very high probability.

The delay measurement is performed, for example, at 1000 frames/second for 10 seconds. In addition, it is assumed that the length of the DM frame is 128 bytes. In this case, a bandwidth used by the DM frame is about 1 Mbps, and does not affect transmission of other control frames.

Note that, in a case where the cycle of transmitting the DM frame is synchronized with another control (for example, a cycle in which the CPU 11 transmits a control frame), all the DM frames may be affected by congestion. In order to solve this problem, the DM frame processing unit 5 may transmit the DM frame in a random cycle when performing the delay measurement a plurality of times.

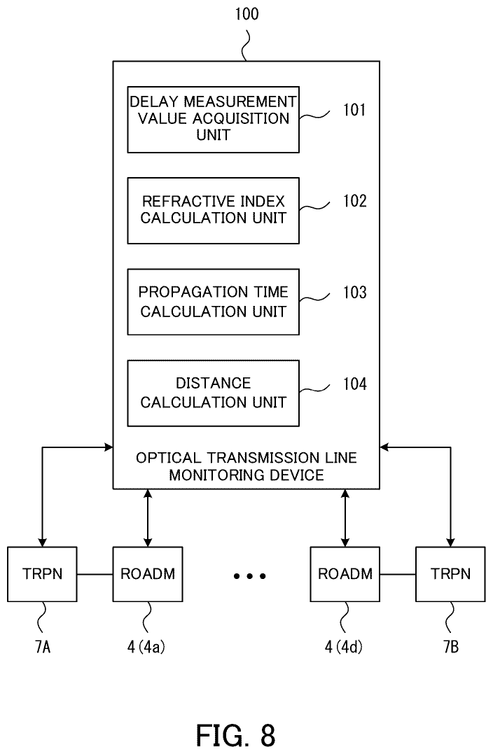

FIG. 8 illustrates an example of a functional configuration of the optical transmission line monitoring device 100 according to the embodiment of the present disclosure. In this embodiment, the optical transmission line monitoring device 100 includes a delay measurement value acquisition unit 101, a refractive index calculation unit 102, a propagation time calculation unit 103, and a distance calculation unit 104. Note that the optical transmission line monitoring device 100 may further have other functions not illustrated in FIG. 8. For example, the optical transmission line monitoring device 100 has a function of communicating with an optical transmission device (in this example, ROADM/ILA 4) provided in each node of the optical transmission line 2. In addition, the optical transmission line monitoring device 100 has a function of communicating with the transponders (7A and 7B) provided in each terminal node. However, the optical transmission line monitoring device 100 may communicate with the transponders (7A and 7B) via ROADMs (4a and 4b). Then, the optical transmission line monitoring device 100 specifies a polarization fluctuation position representing a position where polarization fluctuation occurs in the optical transmission line 2 between the first terminal node (ROADM 4a) and the second terminal node (ROADM 4d).

The delay measurement value acquisition unit 101 acquires a delay measurement value representing a result of delay measurement between nodes for each of a plurality of spans constituting the optical transmission line 2. Note that the ROADM 4 provided in each node performs delay measurement of an adjacent span in response to an instruction from the delay measurement value acquisition unit 101.

The refractive index calculation unit 102 calculates the refractive index of the optical fiber for each span based on the span length and the delay measurement value. When the delay measurement is performed a plurality of times for each span, the refractive index calculation unit 102 calculates the refractive index of the optical fiber based on the span length and the minimum value among the plurality of delay measurement values obtained by the plurality of times of delay measurement. According to this method, it is possible to substantially avoid an influence of congestion of a switch in an optical transmission device provided in each node.

The propagation time calculation unit 103 calculates the propagation time of the light between the first terminal node and the polarization fluctuation position based on timing information indicating the timing at which the polarization fluctuation generated on the optical transmission line 2 is detected in each of the first terminal node and the second terminal node. The distance calculation unit 104 calculates the distance between the first terminal node and the polarization fluctuation position based on the propagation time of the light between the first terminal node and the polarization fluctuation position and the refractive index calculated for each span.

According to this configuration, the polarization fluctuation position is specified using the refractive index calculated based on the delay measurement of each span. Therefore, even when the characteristics (here, the refractive index) of the optical fiber laid in each span have variations, the polarization fluctuation position can be accurately specified.

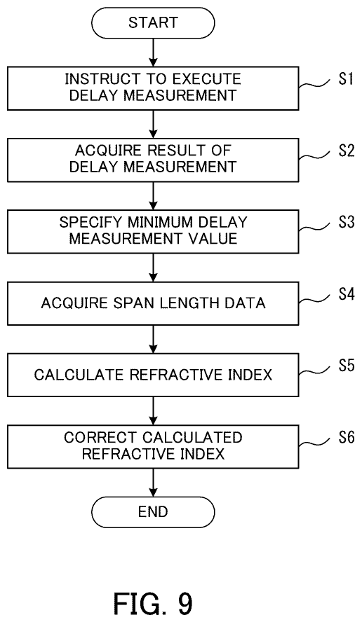

FIG. 9 is a flowchart illustrating an example of a method of calculating a refractive index of an optical fiber laid in each span of an optical transmission line. The process of this flowchart is executed before the polarization fluctuation position is specified. In addition, the process of this flowchart is executed for each span constituting the optical transmission line 2. In the following description, a span in which the process of the flowchart illustrated in FIG. 9 is executed may be referred to as a “target span”.

In S1, the optical transmission line monitoring device 100 instructs execution of delay measurement of the target span. Note that the delay measurement instruction is given to the ROADM 4 provided ai one end of the target span. In response to the delay measurement instruction, the ROADM 4 measures the propagation delay time with the adjacent node using the DM frame. At this time, the ROADM 4 performs a plurality of times of delay measurement. The number of times of delay measurement to be performed may be notified from the optical transmission line monitoring device 100. In addition, the number of delay measurements to be performed may be determined according to the usage rate of the L2 switches that process the signals in the ROADM 4. In this case, the number of delay measurements to be performed is determined, for example, such that the probability of occurrence of congestion of the L2 switch in all delay measurements is lower than a specified threshold.

Alternatively, the number of delay measurements to be performed is determined such that the DM frame is propagated without being affected by congestion of the L2 switch in at least one delay measurement. Then, the ROADM 4 transmits a result of the delay measurement to the optical transmission line monitoring device 100. That is, a plurality of delay measurement values are transmitted to the optical transmission line monitoring device 100.

In S2, the delay measurement value acquisition unit 101 acquires a measurement result from the ROADM 4. That is, the delay measurement value acquisition unit 101 acquires a plurality of delay measurement values for the target span. Then, in S3, the delay measurement value acquisition unit 101 specifies a minimum value among the plurality of delay measurement values for the target span. Note that the minimum delay measurement value is considered to be an accurate delay measurement value that is not affected by congestion.

In S4, the refractive index calculation unit 102 acquires span length data representing the span length of the target span. It is assumed that the span length of each span is known and the span length data is stored in the memory of the optical transmission line monitoring device 100.

In S5, the refractive index calculation unit 102 calculates the refractive index of the optical fiber laid in the target span. The refractive index n is calculated by Formula (3). Note that c represents the speed of light in vacuum. L represents a span length of the target span. The RTT is a minimum value (minimum delay measurement value) among a plurality of delay measurement values obtained by the delay measurement.

$$n = c \times \frac{RTT}{2 L} \qquad ( 3 )$$

In S6, the refractive index calculation unit 102 corrects the refractive index obtained in S5. That is, in this embodiment, as illustrated in FIG. 4, the wavelength of the OSC transmitting the DM frame is different from the wavelength of the C-band transmitting the data signal. As an example, the wavelength of the OSC is 1511 nm and the center wavelength of the C-band is about 1550 nm. On the other hand, the refractive index of the optical fiber depends on the wavelength. Therefore, in order to obtain the refractive index with respect to the wavelength for transmitting the data signal, it is preferable to correct the refractive index calculated for the OSC light.

Here, when the wavelength dispersion D of the optical fiber is represented by Formula (4), the relationship of Formula (5) is obtained.

$$D = \frac{d}{d λ} ( \frac{1}{{v}_{g}} ) \qquad ( 4 )$$

$$\frac{1}{{v}_{g}} {\vert}_{λ = {λ}_{DWDM}} = \frac{1}{{v}_{g}} {\vert}_{λ = {λ}_{OSC}} + {\int }_{{λ}_{OSC}}^{{λ}_{DWDM}} D ( λ ) d λ \qquad ( 5 )$$

The left side of Formula (5) represents the reciprocal of the group velocity of light in the C band. The first term on the right side represents the reciprocal of the group velocity of light at the wavelength at which the OSC is located. The second term on the right side represents a result of integrating the wavelength dispersion D of the optical fiber from the OSC wavelength to the C-band wavelength.

Further, when both sides of Formula (5) are multiplied by c, Formula (6) is obtained.

$$\begin{matrix}{n}_{g} {\vert}_{λ = {λ}_{DWDM}} = {n}_{g} {\vert}_{λ = {λ}_{OSC}} + c \times {\int }_{{λ}_{OSC}}^{{λ}_{DWDM}} D ( λ ) d λ \\ ≅ {n}_{g} {\vert}_{λ = {λ}_{OSC}} + Δ {λ}_{[ n m ]} \times 2.998 \times 1 {0}^{- 6}\end{matrix} \qquad ( 6 )$$

The left side of Formula (6) represents the refractive index at the C band. The first term on the right side represents the refractive index in OSC. The second term on the right side represents a correction amount in consideration of wavelength dispersion. Note that A2 represents a difference between the wavelength of the OSC and the wavelength of the C band. In this example, the wavelength dispersion D is 10 ps/nm/km.

In the embodiments of the present disclosure, delay measurement is performed by utilizing OSC. Thus, the refractive index at the wavelength of the OSC is calculated. Therefore, the refractive index calculation unit 102 corrects the refractive index obtained in S5 based on the wavelength dispersion D of the optical fiber. As a result, the refractive index in the wavelength region (in this example, the C-band) in which the data signal is transmitted is obtained.

The wavelength dispersion characteristic of the optical fiber depends on the fiber type. For example, wavelength dispersion characteristics of a single mode optical fiber (SMF), a dispersion shifted single mode optical fiber (DSF), and a non-zero dispersion shifted single mode optical fiber (NZ-DSF) are different from each other. Therefore, the optical transmission line monitoring device 100 preferably has a function of specifying or estimating the type of the optical fiber laid in each span. In this case, even if the type of the optical fiber laid in each span is unknown, the wavelength dispersion characteristic is specified, and the correction amount of Formula (6) can be obtained.

In this embodiment, the refractive index is calculated based on the RTT of each span. At this time, in the example illustrated in FIG. 6, the DM frame passes through the optical fiber 2x and the optical fiber 2y. Therefore, the refractive index calculated by Formulas (3) to (6) is an average value of the refractive index of the optical fiber 2x and the refractive index of the optical fiber 2y. However, a plurality of optical fibers laid in the same span is usually manufactured by the same vendor in the same manufacturing process and accommodated in one cable. Therefore, it is expected that physical properties (here, the refractive index) of a plurality of optical fibers (Here, the optical fibers 2x and 2y are used) laid in the same span are substantially the same. Therefore, the refractive index calculated by Formulas (3) to (6) is substantially the refractive index of the optical fiber 2x and the refractive index of the optical fiber 2y.

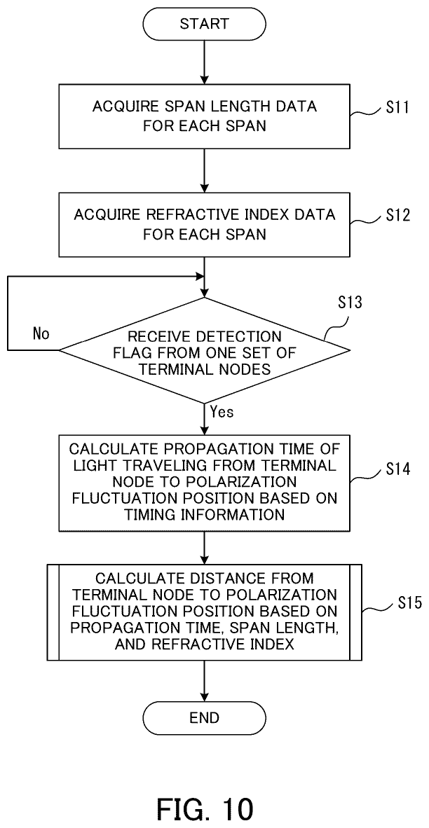

FIG. 10 is a flowchart illustrating an example of a process of specifying a polarization fluctuation position. It is assumed that the refractive index of the optical fiber laid in each span is calculated by the procedure illustrated in FIG. 9 before the process of this flowchart is executed.

In S11, the optical transmission line monitoring device 100 acquires span length data representing the span length of each span. In S12, the optical transmission line monitoring device 100 acquires refractive index data indicating the refractive index of the optical fiber laid in each span. It is assumed that the span length data and the refractive index data are stored in advance in the memory of the optical transmission line monitoring device 100.

In S13, the optical transmission line monitoring device 100 waits for a detection flag transmitted from one set of terminal nodes located at both ends of the optical transmission line 2. Each of transponders (in the example illustrated in FIG. 3, the transponders 7A and 7B) is provided in each terminal node. Each of the transponders 7A and 7B includes a polarization fluctuation monitor 8, and constantly monitors polarization fluctuation in the optical transmission line 2. The polarization fluctuation is detected by, for example, the receiver illustrated in FIG. 5. In this case, when the polarization fluctuation larger than the specified threshold level is detected, the fluctuation determination unit 36 transmits a detection flag to the optical transmission line monitoring device 100. Timing information indicating the timing at which the fluctuation determination unit 36 detects the polarization fluctuation is added to the detection flag. Then, when the detection flag is received from one set of terminal nodes, the process of the optical transmission line monitoring device 100 proceeds to S14.

In S14, the propagation time calculation unit 103 calculates the propagation time required for the light to propagate from the terminal node to the polarization fluctuation position via the optical transmission line 2 based on the timing information acquired from the one set of terminal nodes. Although the propagation time is not particularly limited, for example, the propagation time is calculated using Formula (1) described above. Then, in S15, the distance calculation unit 104 calculates the distance from the terminal node to the polarization fluctuation position based on the propagation time calculated by the propagation time calculation unit 103, the span length of each span, and the refractive index of each span.

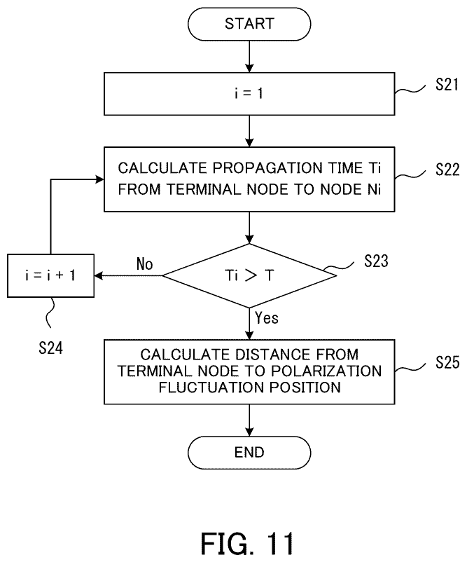

FIG. 11 is a flowchart illustrating an example of a process of calculating a distance from a terminal node to a polarization fluctuation position. The process of this flowchart corresponds to S15 illustrated in FIG. 10.

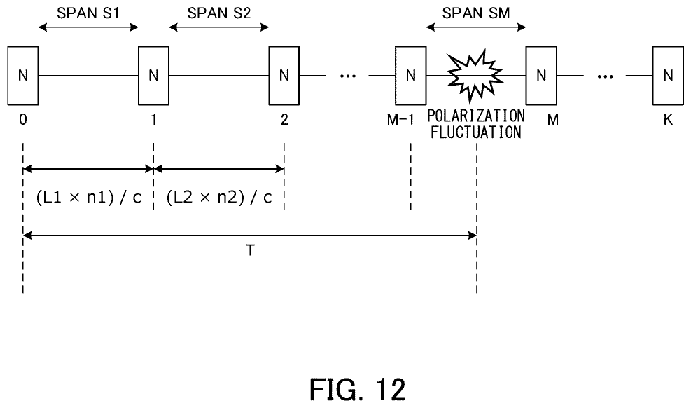

In this embodiment, as illustrated in FIG. 12, the optical transmission system includes nodes N(0) to N(K), and the optical transmission line 2 includes K spans Si (i=1 to K). Each of the node N(0) and the node N(K) is a terminal node of the optical transmission line 2. The span length Li of each span Si is assumed to be known. The refractive index ni of the optical fiber laid in each span Si has been calculated by the procedure illustrated in FIG. 9. The propagation time T during which light propagates from the terminal node N(0) to the polarization fluctuation position via the optical transmission line 2 is calculated by the propagation time calculation unit 103 in S14 of FIG. 10.

In S21, the distance calculation unit 104 initializes the variable i to “1”. The variable i identifies each span.

In S22, the distance calculation unit 104 calculates a propagation time Ti during which light propagates from the terminal node N(0) to the node N(i) via the optical transmission line 2. The propagation time Ti is calculated by Formula (7).

$$Ti = {\sum }_{k = 1}^{i} \frac{{L}_{k} \times {n}_{k}}{c} \qquad ( 7 )$$

When the variable i is “1”, the propagation time T1 during which light propagates from the terminal node N(0) to the node N(1) via the optical transmission line 2 is calculated. That is, the propagation time of the span S1 is calculated. At this time, the refractive index ni of the optical fiber laid in the span S1 is used.

In S23, the distance calculation unit 104 compares the propagation time Ti with the propagation time T. Here, as described above, the propagation time Ti represents a time during which light propagates from the terminal node N(0) to the node N(1) via the optical transmission line 2. The propagation time T represents a time during which light propagates from the terminal node N(0) to the polarization fluctuation position via the optical transmission line 2. Then, when the propagation time Ti is shorter than the propagation time T, the variable i is incremented in S24, and then the process of the distance calculation unit 104 returns to S22. Therefore, the process of S22 to S24 is repeatedly executed until the propagation time Ti becomes larger than the propagation time T.

For example, when the variable i is “2”, the propagation time T2 during which light propagates from the terminal node N(0) to the node N(2) via the optical transmission line 2 is calculated. That is, the sum of the propagation time of the span S1 and the propagation time of the span S2 is calculated.

Then, when the propagation time Ti becomes longer than the propagation time T, the process of the distance calculation unit 104 proceeds to S25. In the following description, as illustrated in FIG. 12, it is assumed that the propagation time Ti is longer than the propagation time T when the variable i is “M”. In this case, the distance calculation unit 104 determines that polarization fluctuation occurs between the node N(M−1) and the node N(M).

In S25, the distance calculation unit 104 calculates the distance D (pol) from the terminal node N(0) to the polarization fluctuation position using Formula (8).

$$D ( pol ) = \frac{c}{{n}_{M}} ( T - {\sum }_{i = 1}^{M - 1} \frac{{L}_{i} \times {n}_{i}}{c} ) + {\sum }_{i = 1}^{M - 1} {L}_{i} \qquad ( 8 )$$

In Formula (8), nm represents the refractive index of the optical fiber laid in the span SM. The second term in parentheses represents a propagation time during which light propagates from the terminal node N(0) to the node N(M−1) via the optical transmission line 2. Therefore, the value in parentheses represents a propagation time during which light propagates from the node N(M−1) to the polarization fluctuation position via the optical transmission line 2. Therefore, the first term of Formula (8) represents the distance from the node N(M−1) to the polarization fluctuation position. Here, the second term represents the distance from the terminal node N(0) to the node N(M−1). Therefore, Formula (8) represents the distance from the terminal node N(0) to the polarization fluctuation position.

As described above, according to the embodiment, the distance from the terminal node to the polarization fluctuation position is calculated using the refractive index of the optical fiber laid in each span constituting the optical transmission line 2. Here, the refractive index fiber is calculated based on delay of each optical measurement performed for each span using OSC. In addition, the value of each refractive index is corrected in consideration of the difference between the wavelength of the OSC and the wavelength at which the data signal is transmitted. Therefore, the distance from the terminal node to the polarization fluctuation position can be accurately calculated, and the polarization fluctuation position can be accurately specified.

Note that the optical transmission line monitoring device 100 is implemented by, for example, a computer including a processor and a memory. In this case, the optical transmission line monitoring program describing the procedure of the flowcharts illustrated in FIGS. 9 to 11 is stored in the memory. Then, when the processor executes the optical transmission line monitoring program, the functions of the delay measurement value acquisition unit 101, the refractive index calculation unit 102, the propagation time calculation unit 103, and the distance calculation unit 104 are provided. In addition, the computer includes an interface for communicating with each node of the optical transmission system.

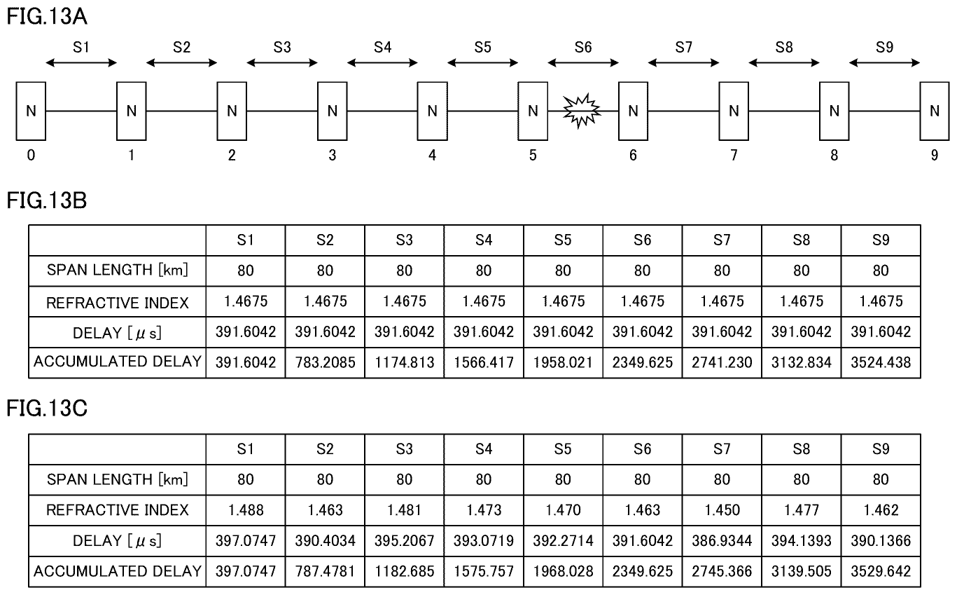

FIGS. 13A to 13C are diagrams illustrating effects according to the embodiment of the present disclosure. In this embodiment, as illustrated in FIG. 13A, the optical transmission system includes a terminal node NO, relay nodes N1 to N8, and a terminal node N9. That is, the optical transmission line is configured of spans S1 to S9. A span length of each of the spans S1 to S9 is 80 km.

In the optical transmission system having the above configuration, when polarization fluctuation occurs on the optical transmission line 2, the optical transmission line monitoring device 100 calculates a propagation time when light propagates from the terminal node NO to the polarization fluctuation occurrence position via the optical transmission line 2. In this embodiment, it is assumed that the propagation time is 2000 μs.

FIG. 13B illustrates a refractive index and a delay in a comparative example for describing an effect of the embodiment. FIG. 13C illustrates a refractive index and a delay in the embodiments. Note that, in FIGS. 13B and 13C, “delay” is a value of ½ of RTT obtained by transmitting the DM frame via OSC. The “accumulated delay” is a value obtained by adding the delays of the respective spans with the terminal node NO as a starting point.

In the comparative example illustrated in FIG. 13B and the embodiment illustrated in FIG. 13C, the procedure of calculating the distance from the terminal node NO to the polarization fluctuation position is substantially the same. That is, the optical transmission line monitoring device 100 calculates the distance from the terminal node NO to the polarization fluctuation position according to the procedure of S15 illustrated in FIG. 10 (S21 to S25 illustrated in FIG. 11). Then, in this embodiment, by repeatedly executing S21 to S24, it is detected that the accumulated delay exceeds “2000 μs” in the span S6. In this case, it is determined that the polarization fluctuation occurs in the span S6 (that is, between the node N5 and the node N6).

Thereafter, the optical transmission line monitoring device 100 executes calculation of Formula (8) in S25. Here, in the comparative example, the representative value “1.4675” is used as the refractive index of the optical fiber of each span. That is, in the calculation of Formula (8), ni (i=1 to 5) and nM (M=6) are both 1.4675. As a result, “412.6 km” is obtained as the distance from the terminal node NO to the polarization fluctuation position. In contrast, in the embodiment of the present disclosure, in the calculation of Formula (8), values obtained by delay measurement are used as ni (i=1 to 5) and nM (M=6), respectively. As a result, “409.6 km” is obtained as the distance from the terminal node NO to the polarization fluctuation position.

Here, the refractive index of a commercially available optical fiber has a variation of about ±1.5% (±0.02 when converted to a value of the refractive index). That is, when the distance between the terminal node and the polarization fluctuation position is about 400 km, the error in the polarization fluctuation position is about ±6 km in the comparative example. On the other hand, in the embodiment, for example, when the measurement of the transmission delay using the DM frame is ±1 μs, the error in the refractive index is about ±0.004. That is, compared with the comparative example, the monitoring method of the embodiment has five times the accuracy. Therefore, the error in the polarization fluctuation position is about ±1.2 km.

Note that, in the above-described embodiment, a DM frame supported by Ethernet or the like is transmitted in delay measurement, but the embodiment of the present disclosure is not limited to this configuration. For example, in a configuration in which an OTN frame is transmitted via the optical transmission line 2, delay measurement may be performed by setting a DM bit provided in overhead of the OTN frame.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical transmission line monitoring device that specifies a polarization fluctuation position representing a position where polarization fluctuation occurs in an optical transmission line between a first terminal node and a second terminal node, the optical transmission line monitoring device comprising:
a processor configured to
acquire a delay measurement value representing a result of delay measurement between nodes for each of a plurality of spans constituting the optical transmission line,
calculate, for each of the plurality of spans, a refractive index of an optical fiber laid in the span based on a span length representing the length of the span and the delay measurement value,
calculate a propagation time of light between the first terminal node and the polarization fluctuation position based on timing information indicating timing at which polarization fluctuation generated on the optical transmission line is detected in each of the first terminal node and the second terminal node, and
calculate a distance between the first terminal node and the polarization fluctuation position based on the propagation time and the refractive index calculated for each of the plurality of spans.

2. The optical transmission line monitoring device according to claim 1, wherein
when the delay measurement is performed a plurality of times for each of the plurality of spans, the processor calculates, for each of the plurality of spans, a refractive index of an optical fiber laid in the span based on a span length of the span and a minimum value of a plurality of delay measurement values obtained by the delay measurement performed a plurality of times.

3. An optical transmission system comprising:
a plurality of optical transmission devices provided on an optical transmission line between a first terminal node and a second terminal node; and
an optical transmission line monitoring device that specifies a polarization fluctuation position representing a position where polarization fluctuation occurs in the optical transmission line, wherein
the optical transmission line is configured of a plurality of spans,
each optical transmission device includes a delay measurement unit that measures a delay time of a span with an adjacent node, and
the optical transmission line monitoring device includes a processor configured to
acquire, for each of the plurality of spans, a delay measurement value representing a result of delay measurement between nodes from a corresponding optical transmission device,
calculate, for each of the plurality of spans, a refractive index of an optical fiber laid in the span based on a span length representing the length of the span and the delay measurement value,
calculate a propagation time of light between the first terminal node and the polarization fluctuation position based on timing information indicating timing at which polarization fluctuation generated on the optical transmission line is detected in each of the first terminal node and the second terminal node, and
calculate a distance between the first terminal node and the polarization fluctuation position based on the propagation time and the refractive index calculated for each of the plurality of spans.

4. The optical transmission system according to claim 3, wherein
the optical transmission line transmits a data signal by using a first wavelength, and
the delay measurement unit
transmits a delay measurement frame to an adjacent node through the optical transmission line by using a second wavelength different from the first wavelength,
receives the delay measurement frame from the adjacent node via the optical transmission line, and
measures a delay time of a span with the adjacent node based on a transmitting time of the delay measurement frame and a reception time of the delay measurement frame.

5. The optical transmission system according to claim 4, wherein
the processor corrects the calculated refractive index for each of the plurality of spans based on a difference between the first wavelength and the second wavelength.

6. The optical transmission system according to claim 4, wherein
the processor corrects the calculated refractive index for each of the plurality of spans based on a difference between the first wavelength and the second wavelength and a type of an optical fiber laid in the span.

7. The optical transmission system according to claim 4, wherein
the processor corrects the calculated refractive index for each of the plurality of spans based on a difference between the first wavelength and the second wavelength and a wavelength dispersion characteristic of an optical fiber laid in the span.

8. An optical transmission line monitoring method for specifying a polarization fluctuation position representing a position where polarization fluctuation occurs in an optical transmission line between a first terminal node and a second terminal node, the method comprising:
acquiring a delay measurement value representing a result of delay measurement between nodes for each of a plurality of spans constituting the optical transmission line;
calculating, for each of the plurality of spans, a refractive index of an optical fiber laid in the span based on a span length representing the length of the span and the delay measurement value;
calculating a propagation time of light between the first terminal node and the polarization fluctuation position based on timing information indicating timing at which polarization fluctuation generated on the optical transmission line is detected in each of the first terminal node and the second terminal node; and
calculating a distance between the first terminal node and the polarization fluctuation position based on the propagation time and a refractive index calculated for each of the plurality of spans.
